(19) United States
(12) Patent Application Publication
(10) Pub. No.: US 2002/0044662 A1
(43) Pub. Date: Apr. 18, 2002

(54) Service message management system and method

(76) Inventor: Jonathan Sowler, London (GB)

Correspondence Address: B. Noel Kivlin, Conley, Rose, & Tayon, P.C., P.O. Box 398, Austin, TX, 78767, US

(21) Appl. No.: 09/934,195

(22) Filed: Aug. 21, 2001

Related U.S. Application Data
(60) Provisional application No. 60/226,820, filed on Aug. 22, 2000.

(51) Int. Cl. H04L 9/00

(52) U.S. Cl. 380/277; 713/156

(57) ABSTRACT

A method for forming a service message for a multi-service environment, said method comprising digitally signing a first part of a service message comprising one or more message components, and digitally signing a second part of said service message comprising one or more message components. The service message is formed from said first and second parts, and first and second digital signatures of said first and second parts. Thus a service message for a multi-service environment is formed wherein first and second parts of the message are signed separately.

### BACKGROUND OF THE INVENTION

The invention relates to a computer, computer system, method and computer program for handling service messages.

Business-to-business electronic commerce is already a significant part of global economic activity. It is predicted that by the year 2003, 9% of total global sales to businesses will be conducted over the Internet. The benefits to business are clear, namely decreased operational costs, access to larger markets and improved customer services, which combine to deliver greater profitability.

Past efforts to implement electronic market places have been hindered by high set-up costs and interoperability issues. Whilst the development of the Internet has addressed, and in great part overcome, the high set-up costs and interoperability problems and thereby focused awareness on the potential for business to business e-commerce, security issues surrounding use of the Internet are holding back the growth of e-commerce. Trading over open networks such as the Internet involves new risks, especially the issue of trusting the identity of trading partners. Systems which check the identity of online parties are therefore required.

Several authorisation, verification and authentication mechanisms are currently in use in Internet based e-commerce systems, employing Public Key Infrastructure (PKI) techniques including digital signatures and digital certificates.

In PKI, pairs of different keys are used, one key of each pair being a “public key”, K_{P}, which can be made public, and the other being a “private key”, K_{S}, which remains secret. It is relatively easy mathematically to derive the public key from its private key, but the opposite is not true. Specific operations with one key can be undone with the other key. For example, if a document is encrypted with a public key it can be decrypted with the corresponding private key, and if a document is encrypted with a private key, it can be decrypted with the corresponding public key. Thus, a complete stranger can use a public key to encrypt a message, but only a specific person with the corresponding private key can decrypt the message. Alternatively, a specific person can encrypt a message with their private key, and complete strangers can decrypt the message with the corresponding public key.

Digital Signatures

Digital signatures are used to verify that a communication has not been tampered with and that it is from the specified sender. Typically a digital signature is contained in a file attached to the relevant communication. A first person, ‘A’, can sign a document by encrypting it with A's private key, K_{S}^{A}. If A then sends the signed document to a second person, ‘B’, B can verify the signature by using A's public key K_{P}^{A} to try to decrypt the signed document. If the public key works, i.e. results in a legible message, then there is a high probability that the signature is verified, verifying that the document was sent by A (or someone who knows A's private key).

In practical implementations, public-key algorithms are often too inefficient to sign long documents. To save time, digital signature protocols are often implemented with one-way hash functions. A hash function is a function, that takes a variable-length input string (called a pre-image) and converts it to a fixed-length (generally smaller) output string (called a hash value or digest). This ‘fingerprints’ the pre-image. The hash function can be public. The security of a one-way hash function is dependent upon its one-wayness. A good hash function for digital signature protocols has an output which is not dependent on the input in any discernible way. A single bit change in the pre-image changes, on average, half of the bits in the hash value. Given a hash value, it is computationally unfeasible to find a pre-image that hashes to that value. In these types of protocols, both the one-way hash function and the digital signature algorithm are agreed upon beforehand.

So, A produces a one-way hash of a document, encrypts the hash with A's private key K_{S}^{A} thereby signing the document, and then sends the document and the signature, i.e. the encrypted hash, to B. B will then produce a one-way hash of the document that A sent. Using the digital signature algorithm, B decrypts the signature with A's public key K_{P}^{A} to derive the signed hash. If the signed hash matches the hash generated by B, the signature is valid.

The amount of information required to be checked is significantly reduced and thus the speed of verification is greatly increased. Since the chances of two different documents having the same n-bit hash are only 1 in 2ⁿ, one can usually safely equate a signature of the hash with a signature of the document.

Digital Certificates

Digital certificates are a form of electronic identification linking an individual to a particular cryptographic key, such as a public key K_{P} in a PKI system. They provide a container for the public key K_{P}, including the name of the owner of the public key and a digital signature of a guarantor of the public key. The guarantor certifies that the information given about the individual is correct and that the public key belongs to that individual. Usually, the certificate is digitally signed by using the guarantor's private key to encrypt a hash of the certificate.

Guarantors of digital certificates are usually called Certification Authorities. They are trusted not to substitute a public key in a certificate with that of another party. A trusted CA, such as VERISIGN, assigns a unique name to each user called the Distinguished Name (DN). CAs issue certificates which include this DN as well as a serial number unique within that CA, the issuer (CA) name, the algorithm used to sign the certificate, the period of validity of the certificate, the user's public key K_{P}^{user}, and the digital signature of the CA.

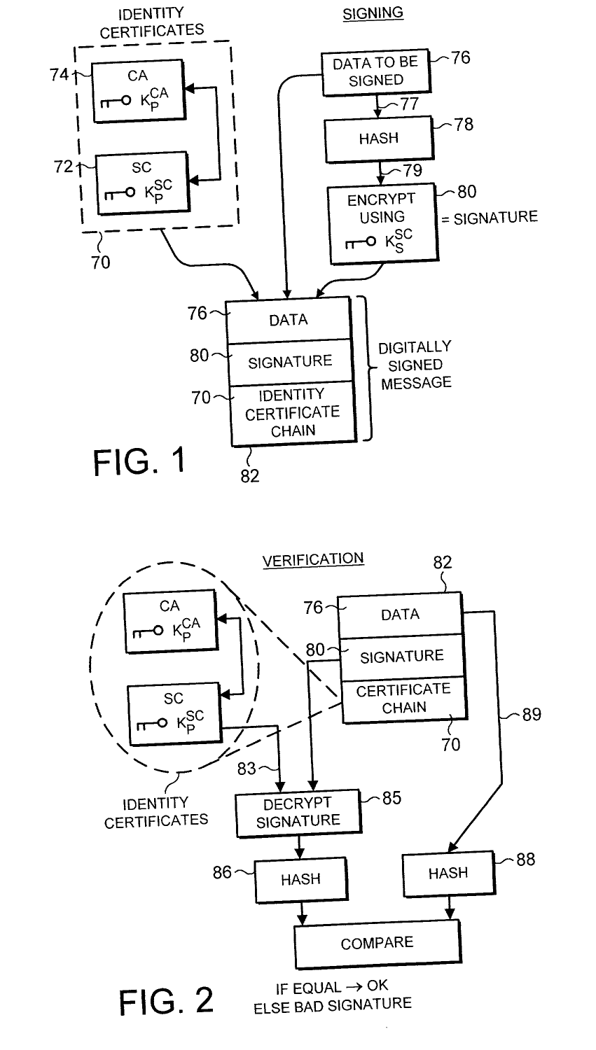

FIG. 1 shows the process of signing a digital message. A subscribing customer SC is issued with (and keeps for a certain length of time, usually five years), a certificate chain 70 and a private key with which it can digitally sign certificates. The certificate chain 70 comprises a certificate 72 including the subscribing customer's public key K_{P}^{SC} and the details about the subscribing customer, signed by a CA, and a certificate 74, including the Certifying Authority's public key K_{P}^{CA}, as well as data identifying that CA, signed by its own secret key if it is a root CA.

In some circumstances an SC may be issued with a private key and certificate together to achieve greater simplicity albeit at the expense of some security. This is preferably achieved by the SC first generating its own private key and using it to sign a request for a certificate. It then sends this request to the CA which then issues the certificate. This procedure is more secure as the private key never leaves the SC's possession.

The data part 76 of a message to be sent by a subscribing customer, SC, is first hashed 77. The hash 78 is then encrypted 79 using the subscribing customer's private key, K_{S}^{SC}, to provide a SC digital signature 80. The data part 76, digital signature 80 and certificate chain 70 are then all combined into a signed message ready to be sent.

FIG. 2 shows the process of verifying the signature of a signed message 82. The public key of the sender (SC) of the message is extracted 83 from the certificate chain part 70 of the message and used to decrypt 85 the signature part 80 of the signed message. This decrypted signature forms the first hash value 86. The data part 76 of the message is also hashed 89, to provide a second hash value 88. These two hash values are then compared and if they are equal the signature is verified. Otherwise it is a bad signature, and the message will be rejected.

One certificate validation service is being developed by a consortium of banks, under the name IDENTRUS. This aims to provide business-to-business financial institution authentication to facilitate financial transactions.

### SUMMARY OF THE INVENTION

In accordance with a first aspect of the present invention there is provided, a method for forming a service message in a multi-service environment, said method comprising digitally signing one or more message components for a first part of a service message, and digitally signing one or more message components for a second part of said service message. A service message is then formed comprising said first and second parts, and first and second digital signatures corresponding to said first and second parts.

In accordance with a second aspect of the present invention, there is provided a service message for a multi-service environment, wherein first and second parts of the message are each digitally signed.

Typically, the service message includes one or more message blocks comprising one or more message components.

In accordance with a third aspect of the present invention, there is provided a method for decoding a service message comprising first and second parts respectively associated with first and second services of a multi-service environment, said method comprising:

receiving said service message at a first service;

verifying only said first part of said message at said service receiving said service message of a second service; and

verifying only said second part of said service message at said second service.

Viewed from a fourth aspect, the present invention provides a computer system for a multi-service environment configured to receive two or more message components for a service message. The computer system is further configured to provide a first digital signature by digitally signing one or more of said message components forming a first part of said service message, and to provide a second digital signature by digitally signing one or more of said message components forming a second part of said service message. The computer system then forms said service message comprising said first and second parts, and first and second digital signatures corresponding to said first and second parts.

In accordance with a fifth aspect of the present invention, there is provided a computer system for a multi-service environment, the computer system configured to:

receive a service message comprising first and second parts respectively associated with first and second services of said multi-service environment;

verify only said first part of said service message for said first service; and

verify only said second part of said service message for said second service.

Viewed from a sixth aspect, the present invention provides a computer network comprising at least one computer system connectable to a least one further computer system via a network, the at least one computer system configured to:

receive two or more message components for a service message;

digitally sign one or more of said message components for a first part of said service message;

digitally sign one or more of said message for a second part of said service message; and

form said service message from said first and second parts, and first and second digital signatures of said first and second parts.

Viewed from a seventh aspect, the present invention provides a computer network comprising at least one computer system connectable to at least one further computer system via a network, the at least one computer system configured to:

receive a service message comprising first and second parts respectively associated with first and second services of said multi-service environment;

verify only said first part of said service message for said first service; and

verify only said second part of said service message for said second service.

Embodiments in accordance with the various aspects of the invention advantageously provide for the independent processing of different parts of the service message. Each digitally signed part of the service message may relate to a different service of the multi-service environment, and first and second parts for example can be sent to respective first and second services in the multi-service environment for processing thereby. Each first and second service can verify or authenticate respective first and second parts without reference to the other part or service. Thus, a common transactional security layer for the services in the multi-service environment is provided by which separate requests for services can be logically separated for processing and non-repudiation purposes. As applications become more complex and comprise many different services, different parts of a service message relating to different services can be removed from the structure together with associated signature material without destroying the coherence of the signature.

Respective services may be operated by the same undertaking or organisation, or may be operated by separate undertakings or organisations.

Optionally, or additionally, at least one message component is common to both said first and second parts of said service message. This is usually the case if some common service needs to be called for both parts of the service message, such as a validation service. Optionally, or additionally, the common components may comprise a transaction or message identifier.

In an embodiment of the present invention, cryptographic data for said message is in a separate part of said message to said first part and said second part. Thus, the cryptographic data can be sent to each first and second service for use in verifying or authenticating said first and second parts separately from said first or second parts. This cryptographic data includes the first and second digital signatures, and may also include other digital certificate data.

Suitably, said first part of said message is associated with a first service, and said second part of said message is associated with a second service. The first and second services respectively comprising a service provided by the first and second services of the multi-service environment. Suitably, one or more of the message components relate to the first service, and one or more other message components relate to the second service.

In an embodiment, said service message comprises one or more message blocks, each comprising one or more message components, thereby forming a suitable message format. The first and second parts may comprise common blocks.

For two or more message blocks comprising said first or second parts of said message, the two or more messages are related to each other. For example, all the blocks relate to the same service with which that part of the message to which they belong is associated.

Typically, embodiments of the invention use public key technology to implement the digital signing.

Embodiments of the invention may be implemented in a message management system to provide a single, unified authorisation service for all services in a multi-service transaction environment. The authorisation service can be used within a single organisation to provide authorisation services across a range of legacy systems, or in a multi-party environment as the basis for commercial services between, for example, banks and their corporate customers, or both.

The message management system enforces policy rules across all applications and services with or in an organisation. It centralises all administration functions and provides a common authorisation service for all business systems. The message management system allows the management of digital certificates and keys belonging to PKI across a number of hardware and software products.

In the foregoing and following discussion of the present invention, the term “service message” is typically used to refer to a message passed between entities such as different services or parties in a multi-service environment requiring an action to be taken by the receiving party on receipt thereof. For example, the service message may comprise an order request and payment, and receiving parties or services respond by fulfilling the order and taking payment for the ordered goods or services.

Particular aspects of the invention are set out in the accompanying independent claims, to which reference should now be made. Combinations of features from the dependent and/or independent claims may be combined as appropriate and not merely as set out in the claims.

Illustrative embodiments of the invention will now be described with reference to the drawings in which:

FIG. 1 schematically shows the signing of a digital message;

FIG. 2 schematically shows the verification of a digital signature;

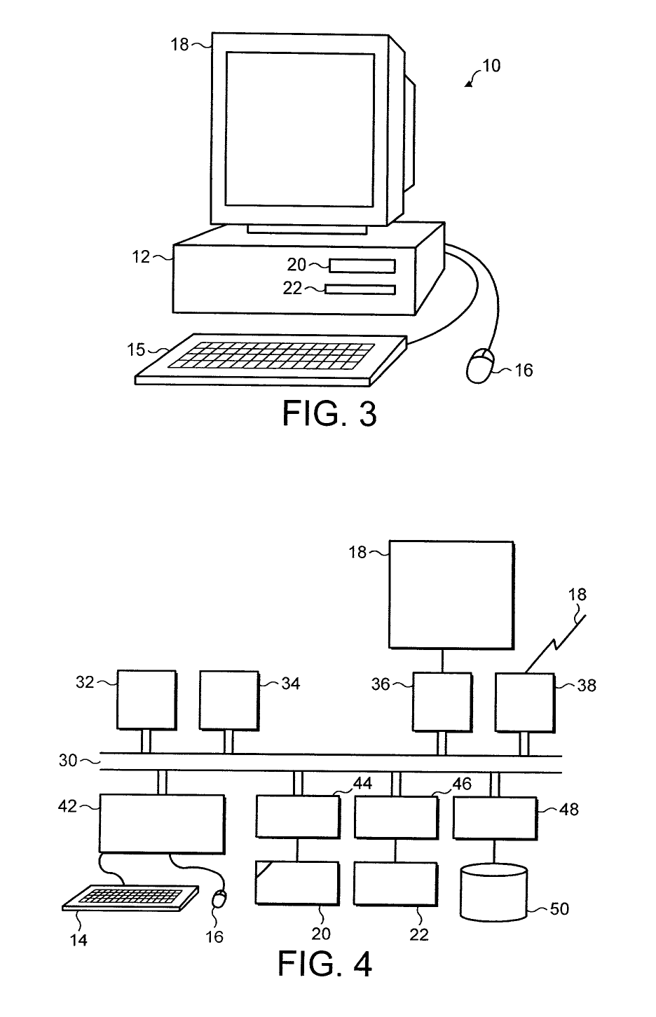

FIG. 3 shows a schematic representation of a computer workstation for an illustrative embodiment of the invention;

FIG. 4 shows a schematic block diagram illustrating an illustrative embodiment of a computer workstation as show in FIG. 3;

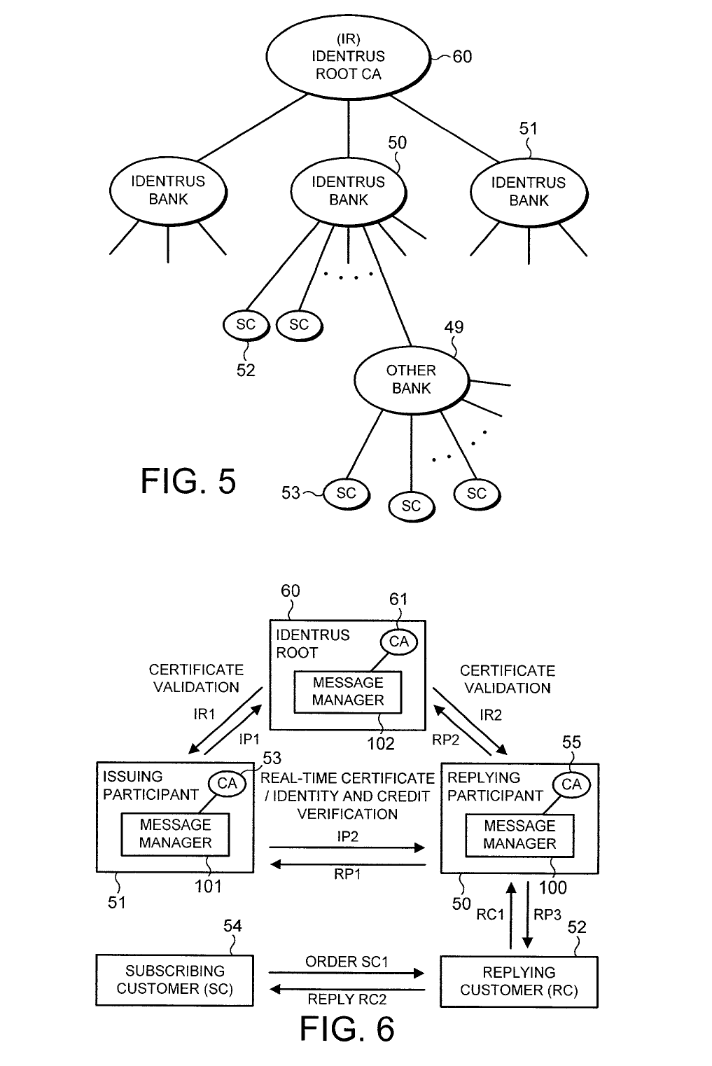

FIG. 5 shows the typical hierarchy of certificate authorisation;

FIG. 6 shows a typical transaction in a network embodying the invention;

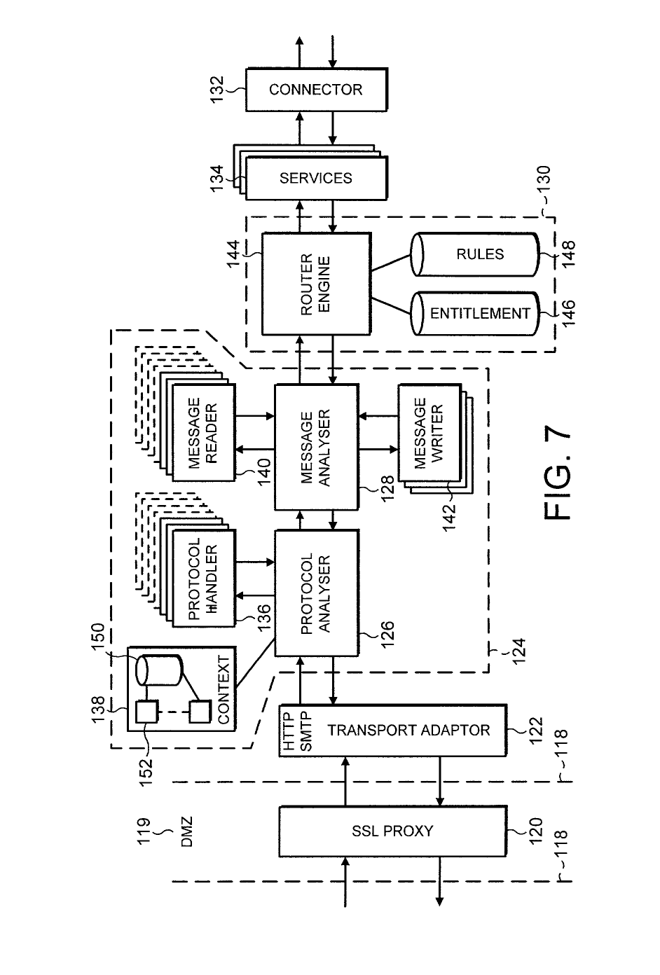

FIG. 7 schematically shows an illustrative embodiment of the transaction manager;

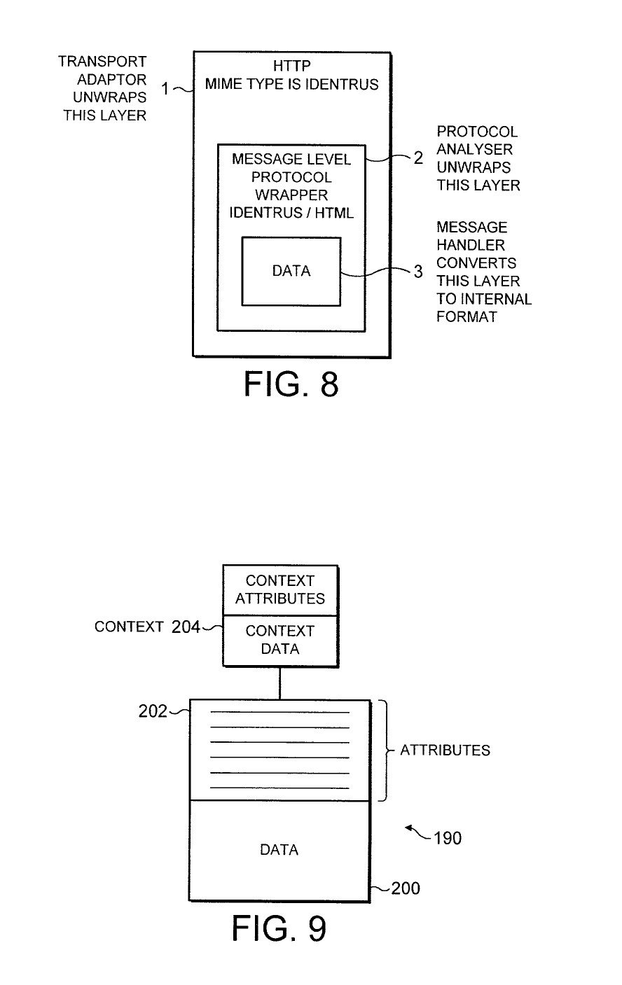

FIG. 8 schematically shows the various protocol layers of a received message;

FIG. 9 shows an example of a trustbase message format;

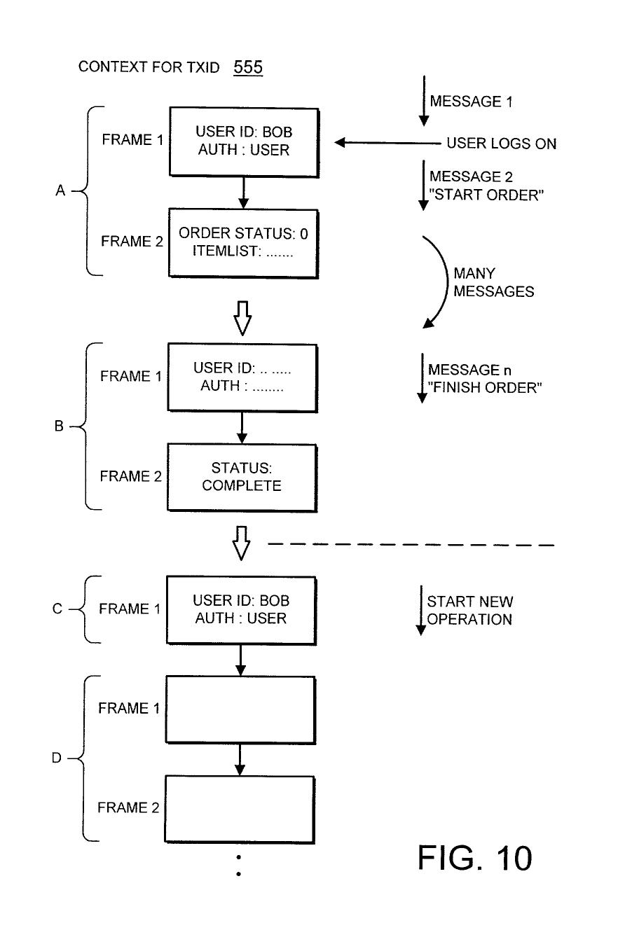

FIG. 10 shows example of the frame stores used for context data;

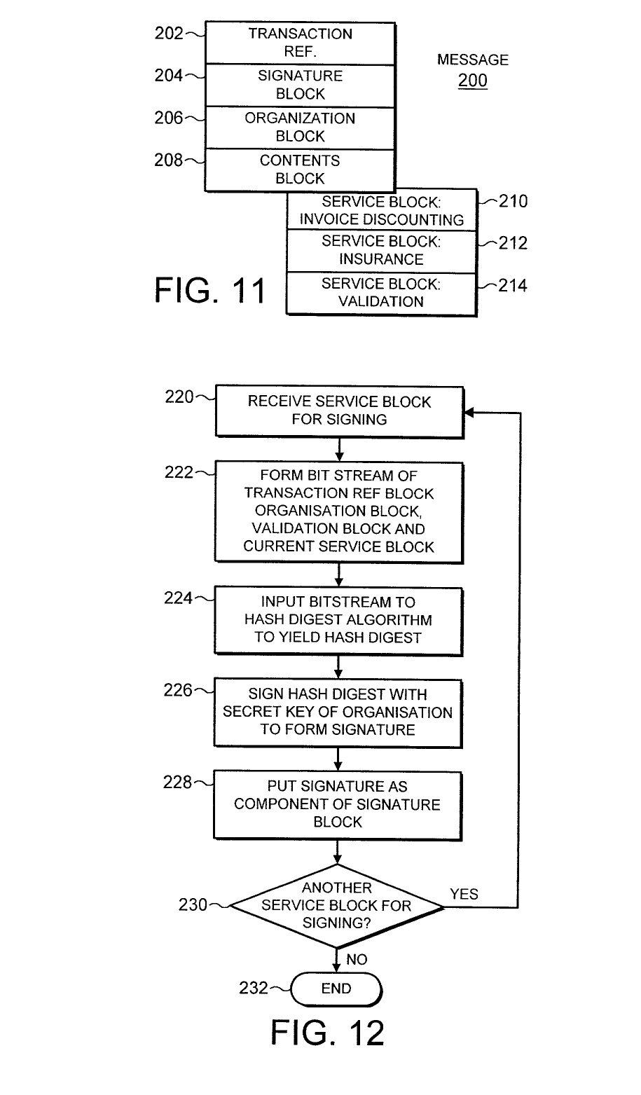

FIG. 11 shows a simple block diagram of a service message structure in accordance with an embodiment of the invention;

FIG. 12 shows a flow diagram describing a method for signing blocks;

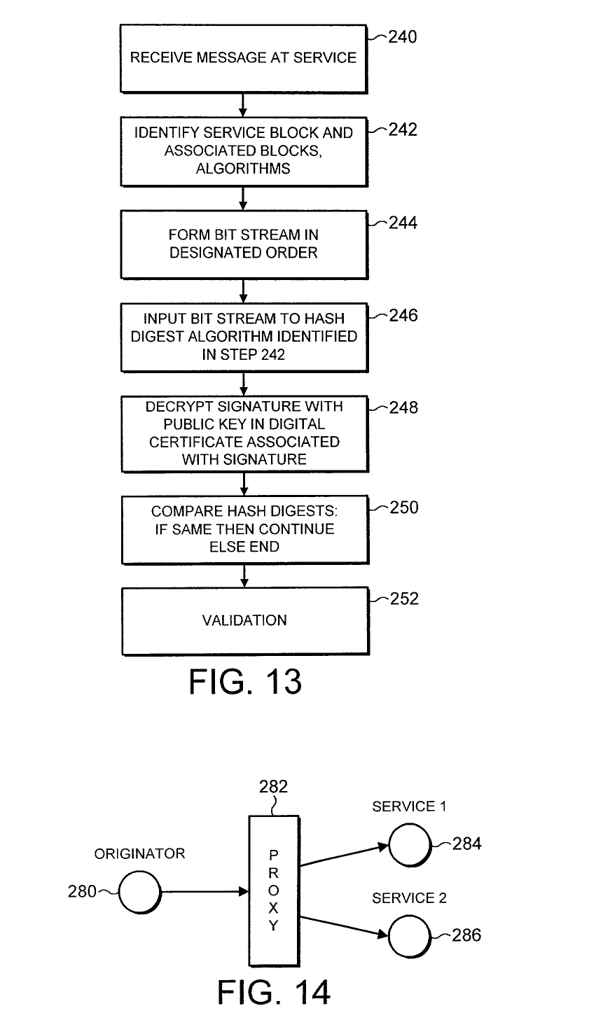

FIG. 13 shows a flow diagram for a method for handling a service message such as that shown in FIG. 11; and

FIG. 14 shows a computer network system in which service messages may be transferred.

FIG. 3 is a schematic representation of a computer workstation on which an illustrative embodiment of the invention is implemented. As shown in FIG. 1, a computer workstation 10 includes a system unit 12 (an example of the configuration of which is shown in FIG. 2), user input devices, for example in the form of a keyboard 14 and a mouse 16, and a display 18. Removable media devices in the form, for example of a floppy disk drive 20 and an optical and/or magneto-optical drive (e.g. a CD, a DVD ROM, a CDR drive) 20 can also be provided.

FIG. 4 is a schematic block diagram showing an illustrative configuration of a system unit 12 as shown in FIG. 3, attached to input devices 14, 16 and a display 18.

As shown in FIG. 4, the system unit 12 includes a bus 30 to which a number of units are connected. A microprocessor (CPU) 32 is connected to the bus 30. Main memory 34 for holding computer programs and data is also connected to the bus 30 and is accessible to the processor. A display adapter 36 connects the display 18 to the bus 30. A communications interface 38, for example a network interface and/or a telephonic interface such as a modem, ISDN or optical interface, enables the computer workstation 10 to be connected 40 to other computers via, for example, an intranet or the Internet. An input device interface 42 connects one or more input devices, for example the keyboard 14 and the mouse 16, to the bus 30. A floppy drive interface 44 provides access to the floppy disk drive 20. An optical drive interface 46 provides access to the optical or magneto-optical drive 22. A storage interface 48 enables access to a hard disk 50. Further interfaces, not shown, for example for connection of a printer (not shown), may also be provided. Indeed, it will be appreciated that one or more of the components illustrated in FIG. 4 may be omitted and/or additional components may be provided, as required for a particular implementation.

An embodiment in accordance with the invention may be implemented in a certificate validation service such as provided by the Identrus system which provides certification services to a customer through the system's bank which will, in turn, verify the customer's identity to trading partners. Customers wishing to use the system must first register and enter into an arrangement with their bank, which authenticates the customer's identity. The customer then typically receives a smart card containing a plurality of certificates and a private key for the customer. The plurality of certificates is a tree of certificates or chain, as shown in FIGS. 1 and 2, each digitally signed and enclosing the public key of the relevant CA.

Additionally, the system will allow banks to guarantee payments by its customers. Such a guarantee would greatly reduce a seller's risk.

Referring to FIG. 5, the certification hierarchy of the above-mentioned IDENTRUS system is illustrated. The root CA is the IDENTRUS root IR 60. This root CA signs its own certificates. At the next level down are the so-called IDENTRUS banks, who are part of the consortium running the IDENTRUS system. These banks 50, 51 etc can act as certifying authorities for each of their customers C 52, as well as for other banks 49 which are not part of the IDENTRUS scheme. These other banks will then, in turn, act as a certifying authority for their customers, C 53.

Referring to FIG. 6, in a particular embodiment, a message manager (“MM”) 100 is provided in each of two banks 50, 51 and in a root authority 60, called the IDENTRUS ROOT in FIG. 6. The MMs provide routing, messaging and identity checking services and can sit in front of the legacy systems of the banks 50, 51.

A transaction will now be described, in which a “subscribing” customer 54 SC, whose bank 51 is called the issuing participant IP, sends an order to a “relying” customer RC 52, whose bank 50 is called the relying participant RP. An example of such a transaction is when a purchaser 54 wishes to make a purchase from a manufacturer 52. The prospective purchaser will send a message to the other party, for example: “How much will you charge me for x units of y?”. In response the manufacturer will wish to forward a proposal, for example “x units of y will cost z”. Both sides will wish to check the identity of the other party and thus they need to send their requests accompanied by a suitable chain of digital certificates and appropriately signed.

To initiate a transaction the subscribing customer (SC) 54 sends an order message (1) to the relying customer (RC) 52, from which it wishes to order something. The SC signs its order as shown in FIG. 1. The data comprising the order is input to a suitable hash digest algorithm to generate a hash digest of the order data. The hash digest is then encrypted using the SCs assigned private key K_{S}^{SC}, thereby providing a signature. The order message is packaged up into message blocks representing the data, the signature, and the chain of identity certificates, thereby creating a digitally signed request message. The data block may instead of containing the actual data relating to the order, contain a pointer indicating where the order information may be found.

On receipt of the order message the relying customer RC first verifies the SC's signature. In order to do this the RC has to extract the SC's public key K_{P}^{SC} from the digital certificate chain included in the order message. A typical digital certificate chain comprises at least the IP identity certificate (signed by the Root CA), which identifies the IP CA. The data part may instead of containing the actual request data relating to the order, contain a pointer indicating where the order information may be found.

On receipt of the order message, the relying customer RC will first verify the signatures, that is both those in the identity certificates as well as the digital signature of the hash. First it will verify the signatures in the identity chain. It will extract the necessary public keys (SC's, IP's) from the identity certificates, and the Root CA public key K_{P}^{root} from a locally stored or network accessible Root CA certificate, and use these to verify the SC's message. The data in the IP certificate is then input to the hash digest algorithm identified in the IP certificate to generate a second hash digest which is compared with the first hash digest to see if they are the same. If they are the same, then the signature is good and the IP certificate is authenticated.

The RC then proceeds to extract the IP's CA public key K_{P}^{IP} from the authenticated IP certificate, and uses this to decrypt the IP's signature on the SC's certificate to obtain a hash digest. The RC also identifies from the SC certificate which hash digest algorithm was used to generate the IP signature and uses that algorithm to generate a hash digest of the SC certificate data, which is compared with the decrypted hash digest. If the two hash digests are the same then the IP signature is verified and the SC certificate is authenticated. The RC extracts the SC public key K_{P}^{SC} from the SC certificate, and uses it to verify the SC signature of the order message by decrypting the signature to obtain a hash digest, and generating a hash digest of the order message data.

If the signatures are verified OK, the RC 52 will next need to check that the SC's identity and the IP's CA signing certificates have not been revoked, that is are still valid. So RC 52 will send a service request message (RC1), often called a Certificate Status Check (CSC) message, to its bank 50, the RP, including a request for a check on the status of the SC's identity certificate,and on the status of IP's CA signing certificate. This request message is signed by the RC's identity private key, K_{S}^{RC}, and contains the RC's identity certificate.

The RP's Message Manager 100 will receive this request message (RC1). The RP Message Manager extracts the RC's Identity public key from the RC's identity certificate and uses this public key to verify the RC's signature on RC1. RP also extracts the RP CA public key from the RP CA certificate stored locally, or from that contained in the certificate chain of RCs identity certificate, and uses this public key to check the RP CA signature on the received RC Identity certificate. This verifies the authenticity and integrity of the RC's request message RC1. If this request message is authentic, the RP Message Manager uses the RC's request message to construct a request message (RP1) to the Issuing Participant's (the IP's) Message Manager 101. This request message RP1 is re-signed by the RP Message Manager using the RP's Inter-Participant private key, and contains the RP Inter-Participant certificate. “Inter-Participant” private keys are those used to sign communications between Identrus participants, each participant having a unique private key.

The IP Message Manager 101 extracts the RP's Inter-participant public key from the RP's Inter-participant certificate, and uses this public key to verify the RP's signature; extracts the Root CA public key from the Root CA certificate stored locally, and uses this public key to check the Root CA signature on the RP Inter-participant certificate. This verifies the authenticity and integrity of the RP's request message. If this request message is authentic, the IP Message Manager 101 sends a request message (IP1) asking for the status of the RP's Interparticipant certificate, to the Identrus Root. The request message IP1 is signed by the IP Message Manager using the IP Interparticipant private key, and contains the IP Inter-Participant certificate.

On receipt of IP1, the IR Message Manager extracts the IP Inter-Participant public key from the IP Inter-Participant certificate, and uses this public key to verify the IP Message Manager signature, and extracts the Root CA Signing public key from the Root CA certificate stored locally, and uses this public key to check the Root CA signature on the IP Inter-Participant certificate. This verifies the authenticity and integrity of IP's request message. If this request message is authentic, the Identrus Root Message Manager processes the request, that is checks the validity of the RP's Inter-Participant certificate and returns the status of that to the IP Message Manager. IR's response message (IR1) is signed with the Identrus Root Inter-participant private key, and contains the Identrus Root Inter-Participant certificate.

On receipt of IR1, the IP Message Manager extracts the IR Inter-Participant public key from the IR Inter-Participant certificate, and uses this public key to verify the IR signature. It also extracts the Root CA public key from the Root CA certificate stored locally, and uses this public key to check the Root CA signature on the IR Inter-Participant certificate. This verifies the authenticity and integrity of IR's response message. If this message is authentic, the IP Message Manager processes the original request from the Relying Participant for the status of the SC certificate, and returns the status of the SC Identity certificate to the RP Message Manager. The response message (IP2) is signed with the IP Inter-Participant private key, and contains the IP Inter-Participant certificate. To process the original request from RP, IP will check its own certificate database 53 to see whether SC's certificate is still valid.

On receipt of IP2, RP will first verify the signatures and then send a request message RP2 to IR including a request to check the validity of IP's certificates, that is both the IP Inter-Participant certificate as well as the IP CA certificate. To do this the RP extracts the IP Inter-Participant public key from the IP Inter-Participant certificate, uses this public key to verify the IP signature, and then extracts the Root CA public key from the Root CA certificate stored locally, and uses this public key to check the Root CA signature on the IP Inter-Participant certificate, thus verifying the authenticity and integrity of the IP's response message, IP2.

If this message, IP2, is authentic, the RP sends a Certificate Status Check request message RP2 to the Identrus Root asking for:

1. The status of the IP Inter-Participant certificate;

2. The status of the IP CA Signing certificate; and

3. Its own certificate for signing RC messages.

The request message RP2 is signed with the RP Inter-Participant private key, and contains the RP Inter-Participant certificate.

Next, IR will verify RP's signature and then check its database 61 to determine the validity of IP's certificate. The Root Message Manager extracts the Root CA public key from the Root CA certificate stored locally, uses this public key to check the Root CA signature on the RP Inter-Participant certificate, extracts the RP Inter-Participant public key K_{P}^{RP} from the RP Inter-Participant certificate, and uses this public key to verify the RP signature; this verifies the authenticity and integrity of RP's message, RP2.

If this message, RP2, is authentic, the Root Message Manager processes the request, and returns to the RP Message Manager:

1. the status of the IP Inter-Participant certificate;

2. the status of the IP CA certificate, and

3. the status of the RP RC certificate.

The response message, IR2, is signed by the Root Inter-Participant key, and contains the Root Inter-Participant certificate.

If IR's response message, IR2, to RP indicates that IP's certificate is valid, RP will send its customer, RC 52, a Certificate Status Check Service response message, RP3. This includes a signed, time stamped Certificate Status Check of his own credentials obtained from the Identrus Root. Without this the message fails. The checking procedure carried out by RP before sending message RP3 is as follows.

The RP Message Manager extracts the Root CA public key from the Root CA certificate stored locally, uses this public key to check the Root CA signature on the Root Inter-Participant certificate, extracts the Root Inter-Participant public key from the Root Inter-Participant certificate, and uses this public key to verify the Root signature; this verifies the authenticity and integrity of the Root's message IR2.

If this message, IR2, is authentic the RP Message Manager can trust the Root Message Manager, the IP Message Manager, and the status of the SC Identity certificate. Then, the RP Message Manager sends a message (RP3) responding to the RC's original request and containing:

1. the status of the SC Identity certificate. Note that if any of the back office checks on the IP fail, then the SC check is marked as a failure; and.

2. the RP certificate status check response from the Identrus Root.

This message, RP3, is signed with the RP relying-customer private key, and contains the RP Relying Customer certificate.

The RC must check the signature and time stamp of the Identrus Root check received through the Relying Participant. The software in use by the relying party should implement a time limit parameter for accepting time stamped credentials of the Relying Participant. Where a time stamp falls outside this period, the message fails. A message, RC2, responding to the original request message is sent by the Relying Customer, confirming or denying the request, as appropriate based on the Certificate Status Check response received by RC.

Referring to FIG. 7, the main components of a message manager 100, 101, 102, in the preferred embodiment, include a secure socket layer (SSL) proxy 120, transport adapter 122, parser 124, router 130, plurality of services 134, and a connector 132. The SSL proxy provides a multi-channel input and uses PKI methods to authenticate the end points of communications, providing privacy from third parties. It exchanges digital signatures and checks them.

The transport adapter 122 deals with the specifics of mail/transport protocols such as Hyper Text Transfer Protocol (HTTP) and Simple Mail Transfer Protocol (SMTP). It subtracts the transport protocol from an incoming message, unwrapping the transport protocol layer. The transport adapter reads any Multimedia Internet Mail Extension (MIME) type of the message, and passes this, along with the partially unwrapped message to the parser 124.

The parser 124 translates the incoming message into the Message Manager's internal format, which will be described later, and then passes the message on to the router 130. The parser comprises a protocol analyser 126, a plurality of protocol handlers 136, a context engine 138, a message analyser 128, a plurality of message readers 140, and a plurality of message writers 142.

The protocol analyser (PA) 126 has two main responsibilities, namely to establish the context for the message, and to determine the type of the data contained in the message, that is the format in which the data is in, for example html or IDENTRUS format. Each protocol handler is configured to ‘understand’ a particular type of message. The PA determines the type of data from the transport/main protocol used. Depending on the type of data and context of the message determined the protocol analyser selects a protocol handler, and passes the message to the selected handler. The protocol handler then strips away the message level protocol wrapper. The message is next passed to the message analyser.

The message analyser (MA) 128 passes the message on to one of the plurality of message readers 140, selected in dependence on the message level protocol used which is notified to the MA by the PA. The message reader then converts the message from that message level protocol into an internal format and then passes the message on to the router 130.

A message 190 in the internal format of the MM, called herein a trustbase message, comprises two parts, as shown in FIG. 9, namely an attribute part which identifies a plurality of attributes of the message including by what protocol the data arrived, details of any digital certificates, the SSL client, etc., and a data part of the message has an associated context packet which identifies the context of the operation, and will be described later in more detail. The data part 200 is usually opaque to the Message Manager framework, and the framework only needs to read the information listed in the attributes section 202 of the trustbase message in order to determine how to deal with the trustbase message 190. The data part may be read and changed by the services.

As the message is unwrapped by the protocol analyser, protocol handler and message reader, each piece of information which is known about the message is written into an attribute section.

Possible attributes include a role, a message type and the state of the message. The roles are defined by the services. The state may be one of authenticated or authorised. Authenticated means that the identity of the user has been verified by a verification service. Authorised means that a check that the user is authorised to access a particular service has been made.

The router 130 may route the trustbase message to one or more services 134, which perform some action using the data part 200 of the trustbase message. The router comprises a routing engine 144, an entitlements database 146 and a rules database 148.

The router 130 has two main functions, that is, primarily, routing messages according to its rules, and secondarily, modifying the attributes of a message.

The router routes a trustbase message by looking at its attributes. The routing engine 144 looks in its rules database 148 and applies the rules contained in the database to the attributes 202 of the message 190, to decide to which, if any, service 134 the message 190 should be sent. For example, if the message attributes 202 indicate the message 190 to be a request for an IDENTRUS status check, the rules database decides that the message should be addressed and sent to the IDENTRUS status checking service. The rules comprise Preconditions which if met indicate that certain Actions should be carried out. Each set of Preconditions leads to one Action only. The preconditions typically act on the attributes of a trustbase message only.

Before sending a message to a service, the router checks with its entitlements database 146 that the user is entitled to access that service, using the data held in the attributes section 202.

An example of rule-based routing is as follows:

RuleSet “configureX”

Rule “Configure”

IF state is “null”

AND messageType is “A”

THEN call service “configureX”

Rule “Authenticate Administrator”

IF state is “postX” AND messageType is “A”

THEN perform “authenticate administrator”

USING this message

Etc.

Each rule, for example Rule “Configure” and Rule “Authenticate Administrator”, belongs to a set of rules, for example the set “configureX”, where X is the name of a particular service on the system. The router deals with a message in accordance with its rules, and check through these starting at the top of the list and working down. For example if the message is a new message and has the preconditions that its state attribute is “null” and that its messageType attribute is “A” then the service “X” will be called by virtue of the Action contained in rule “Configure”. Service X will carry out its function on the message and then change the “state” attribute of the message to indicate that the message has been through the function of that service, that is that it is “post-X”. The returning message would next be sent, in accordance with Rule “Authenticate Administrator” to perform the service “authenticate administrator”. If the messageType had not been “A” or if the state of the message had been different then the router would have moved on to check the attributes of the message against the next rule in the list.

There are two forms of Actions which may be specified in the rules. An “Execute Service” Action where an authorisation check must first be carried out by the Entitlements engine before sending on the message to the service; and an “Unauthorised Execute Service” Action where the service may be accessed without the authorisation check being carried out.

To improve the ease of routing and so that the system is flexible, services apply roles into which messages are sorted in dependence on their attributes. Once a role has been assigned the entitlements engine can easily check authorisation to a service by checking that there is a mapping between that role and the service to which the message is heading.

The services 134, which are provided in the message manager, are typically provided in the form of plug-ins. There may be any number of them in the message manager, and a message can be sent to any number of services in turn, in dependence on the rules.

The router decides on where a message should be sent using the attribute data 202 and context 204 only, that is without looking at the content of the data pay load itself (Although this is not essential and the router may also check the contents of the data part 200). Therefore, the services have to change the attributes of a message to indicate to the router what that service has done to the data contained in the message, or to which service the message should next be sent. The services read and, if necessary, modify the data 200 contained in the trustbase message.

In addition to the internal services 134 of the message manager, the message manager is able to route an incoming message to an external service (not shown in FIG. 6), for example to the bank's certificate database or to a message manager of another certification authority. This message is sent through the connector 132 which does the inverse of the parser. It comprises its own protocol analyser and message analyser (not shown), and uses the message writers 142 and protocol handlers to write a message to be sent to an external service, and to wrap the message up, by adding the required message level and transport level protocols.

Referring again to FIG. 6, message RC1 is received through the front end of the MM100 of the RP that is through its parser, and message RP1 is sent from the connector of RP's MM and received at the front end of IP's MM 101. Message IP1 is sent from the connector of IP's MM 101 and received by the MM 102 of Identrus root through its parser. IR1 is sent back to the IP through the IP MM's 101 parser, that is out of the front end. IP2 is sent from the connector of the IP's MM 101 and received at the front end of RPs MM 100. RP2 is sent through the back end of MM 100, that is the connector of RP's MM 100, and received at the IR through the parser of its Message Manager. IR2 is sent through the front end of IR's MM 102 and received through RP's MM 100 front end. Finally, RP3 is sent through the front end of RP's MM 100.

One function of the protocol analyser (PA), namely establishing a context, will now be described in more detail. A context gives an indication of the state of an operation and this feature is particularly useful in respect of a transaction including a sequence of client/server messages. When a message is received by the message manager, the protocol analyser checks whether the message relates to a one or more messages which it has already processed, or whether this is the first message of a new message. For example a message may have been sent to the message manager in response to a request. The service will need to be able to tell whether a message received is the requested response, or something else. So a ‘context’ is needed.

The selected protocol handler determines a transaction ID (TXID). If an external TXID, that is one generated by some other non-MM apparatus is present in the message, that can be used. If a MM TXID is present that can also be used. Failing either of these the message is assumed to belong to a new message and the PA generates a new internal TXID.

The PA uses the TXID to look up a context from a database. If no context is found, a new one is created. The context is used where a series of messages will be involved in carrying out a single operation. Whilst the message may be sent out from the MM, the MM must be able to retain information about the state of the operation or transaction being carried out. So a “context” is set up. Whilst the message is in the MM the status of the message can be deduced from the context associated with the message and from the attributes of the message. When the message is sent out of the Message Manager the context will be stored and then later be reattached to the next incoming message having the same transaction ID.

An example will now be given referring to FIG. 10. A first message initiating a transaction may be sent from a client to the message manager including a message identifier “555”. This message could, for example, comprise a simple logon request. The selected protocol handler will detect the presence of the TXID 555 and the PA will then check to see whether there is a context stored in its database in respect of this ID.

If not, then a new context, represented by one or more frames, will be set up. In FIG. 10, a new context A, represented by two frames is set up. The first frame includes a user name or user ID and authorisation status of the user. A second frame includes an order status for a first operation. At any one time the context may be represented by one or more frames, which are updated as each step of a message takes place. When the first operation is complete (B) the second frame is deleted. The context then contains (C) just the first frame identifying the user details. Then, when the next operation is started one or more sub frames (frame 2D) will be created to include details about the status of that operation. Typically, the second frame will, in addition to including a status order, include an item list, listing the different items or tasks which must be completed in that operation.

The context is associated by the PA with the trustbase message before it is passed on to the router. Later, when the message leaves the system, for example when the message manager sends data to the client, the context of the message is stored in the context database.

Sometimes a service cannot deal with a request without first obtaining further information. For example a bank account number service may only be allowed to be accessed, according to the rules in the rules database, once the client's identity has been verified. Thus before a request “give me my account details, please”, can be answered, a subsidiary round of correspondence between the client and the MM is required, for example where the rules lay down that the account number service may not be accessed until the user has answered a security question. This subsidiary correspondence will include the same transaction identifier as it is part of the same transaction, but it will need to be identified as relating to a different context being a message belonging to the subsidiary round of correspondence only. Thus “sub-contexts” are used, identified by sub-frames in the context engine, and the router will replace the context attributes of the trustbase message with a sub-context, and invoke an authentication service. So in our example the Authentication Service will send a message, “Answer security question Z”, to the client under the TX ID 555, and the PA will create a sub-frame and store therein an indication of the status of the operation, referenced to that TX ID, in the context database. Then when the next message having the message identifier 555 is received, the PA, by searching through the context database, will find the appropriate context to be associated with the trustbase message. The trustbase message as well as the associated context will be passed to the Authentication checking service, which checks the answer provided by the user, and which will then modify the attributes of the message packet to indicate that the security question has been successfully answered. The service then passes the message back to the router and modifies the context of the message to reflect that the user has answered the security question correctly.

In a particular embodiment, the Authentication engine automatically checks the digital signature of every message which the Message Manager receives from outside, before conducting any further checks. The authentication engine will then modify the attributes of the message to indicate that the verification has been carried out.

The router may also modifies the context of a message by changing the attributes of the context and of the message itself. The router may, depending on the rules, pass the message to the account number service, now that the attributes indicate that a security n identity check has been made. The account number service will then look up the account details and modify the data part of the trustbase message to include the account details and the attribute part to indicate that the data part includes the account details. The modified message is then passed back to the router which will then delete the sub-context for the operation of obtaining the account details and pass the message on to the protocol analyser. The message manager will maintain a context for the transaction so that it knows that it has already verified the identify of the client. Before sending the account details, the message manager will update the context for that message identifier to indicate the new status of the transaction so that it is ready to deal with the next request from that user. The parser will package the message by adding the appropriate message level and transport level protocols, before sending the account details to the client.

A trustbase message which has gone through both of the steps above will have attributes indicating that the identity has been checked and that the account details are included in the data part. Such a message may, according to the rules and because of these attributes, be able to access certain extra services, for example a service to withdraw money from that account.

Referring now to FIG. 11, there is illustrated a simple block diagram of an illustrative embodiment of a service message structure, such as for an order request message. The service message 200 illustrated in FIG. 11 is primarily directed to obtaining insurance, but other services are also requested, such as a request for invoice discounting. The service message 200 comprises the DATA part of the message structure illustrated in FIG. 8 and can be converted into the internal format illustrated in FIG. 9 to form a trustbase message.

In an embodiment of the invention, the message 200 is an XML document. The message comprises a number of message blocks 202-214.

The first message block illustrated in FIG. 11 is the transaction reference block 202. The transaction reference block contains information which describes the transaction and the message. In particular, it comprises a transaction ID component which uniquely identifies the transaction. The transaction identity component is the same across all messages which are part of a single transaction. The transaction reference block 202 further includes a message ID component which identifies and describes a message within a transaction.

The signature block 204 contains cryptographic data for the service message comprising one or more signature components and their associated certificates. In a preferred embodiment of the invention, each signature component contains a digital signature and the associated digital certificate. The signatures may be based on hash digests of combinations of the transaction reference block 202 and one or more other blocks in the message or components of those blocks. Further, the signatures may be based on digests of combinations of the transaction reference block and other blocks or components in any message in the same transaction as identified by the transaction identity component referred to above.

Signature block 204 also includes information relating to the signature method or algorithm used for signing the hash digest, together with the set of object references, that is the relevant message blocks with which the signature is calculated. That is to say, those message blocks which are used to form a hash digest which is subsequently signed. Additionally, the signature block contains the identity of the hash digest algorithm that was used to generate a hash digest of the relevant message blocks. Optionally, the hash digest algorithm identity may be contained in another part of the message.

The organisation block 206 carries structured data about the organisation and can be referred to from other application elements in the messages. The organisation block is referred to by the data element in the transaction ID, which identifies the organisation from which the message originates. The payload for the message 200 is comprised in a contents block 208 which comprises one or more service blocks 210, 212, 214 relating to services requested by the message 200.

In an embodiment of the invention, each service block comprises an XML element which contains a predefined set of components. Each component is an XML element containing a predefined set of XML elements and attributes containing information required to support an exchange within the transaction.

The contents block 208 of the service message illustrated in FIG. 11 comprises a service block 210 which initiates an invoice discounting service, a service block 212 related to obtaining insurance, and a validation service block 214. In a preferred embodiment of the invention, the validation service block 214 is always present in the contents block 218 and is used to initiate a validation service for the signatures and digital certificates contained in signature block 204, such as the authorisation service described above.

The service message 200 illustrated in FIG. 11 is constructed such that different service blocks 210, 212 have separate independent signatures. This is advantageous since, as applications within the multi-service environment become more complex and comprise more and more different services in order to provide an application, it becomes necessary to be able to sign distinct sets of service blocks, dependent upon which service is being requested within each application. In this way, applications and value added components may be layered onto an underlying core service relatively simply.

The cross-hatched blocks 202, 206 and 214, that is the transaction reference block, the organisation block and the validation service block, are combined with service block 210 and formed into a bytestream for input to a hash digest algorithm.

The hash digest produced from hashing the bytestream of blocks 202, 206, 214 and 210, is encrypted with the secret key of the organisation identified in organisation block 206 to form a first signature which is then stored in signature block 204 together with the digital certificate for that organisation.

Additionally, a bytestream is produced of transaction reference block 202, organisation block 206, validation block 214 and insurance service block 212 which is input to a hash digest algorithm to produce another hash digest. This hash digest is then encrypted with the secret key of the organisation to form a second signature which is stored in signature block 204, again together with the digital certificate of the organisation identified in block 206. The digital certificate may comprise a digital certificate chain rather than just a single digital certificate. Additionally, the digital certificates need not be stored with the signatures to which they relate, but may be stored in a separate part of the signature block or a separate cryptographic data block, for example.

Signature block 204 thus comprises a first signature relating to the invoice discounting service requested in service block 210 and another a second signature relating to the insurance service requested in service block 212. Each signature signs a combination of the block of the service to which it relates, as well as the common blocks, that is the transaction reference block (202), the organisation block 206 and the validation service block 214. The services 210, 212 can now be separately requested and initiated independently of each other.

In an embodiment of the invention, in which the message 200 comprises an XML message, a canonicalizer algorithm is used to compute the bytestream for input to the hash digest algorithm. The canonicalizer algorithm provides a precise definition on how to create the bitstream from an arbitrary XML structure. The XML processor in the message manager is compliant with the canonicalizer specified in the XML signature block. However, if an XML processor receives a signed message using a canonicalizer that it does not support, then that message cannot be validated. The bytestream is input to a suitable hash digest algorithm, which may be a canonical digest algorithm which is tailored for the particular content type found in message 200. Such a digest algorithm generates a hash digest which depends upon the core semantics of the content. Optionally, a surface string algorithm may be utilised, which does not have any particular knowledge about the content being input and merely operates on the raw content value. Any changes in the surface string of a given content affect the value of the hash digest being produced. This is in contrast to the canonical digest algorithm in which changes limited to the surface string of a given content do not affect the value of the digest being produced. A particular embodiment of the invention utilises the DOM-HASH XML canonical digest algorithm proposed by IBM Tokyo Research Laboratory.

Turning now to FIG. 12, there is illustrated a flow diagram which describes a method for signing blocks referring to different services in order to form a service message such as illustrated in FIG. 11. The method may be implemented on a computer system such as a computer workstation described with reference to FIG. 3 above. The workstation may also embody functions associated with any one of the entities of the system described above with reference to FIG. 6, for example subscribing customer, buying customer, issuing participant, buying participant and IDENTRUS root. The implementation of the method is by way of a computer program or program element comprising program code running on the computer system, and which may be supplied to the computer system on any suitable carrier medium. For example, the carrier medium may be a magnetic disc or tape or optical disc, for example. Optionally, the computer program or program element may be delivered to the computer system by on-line communication such as over the Internet and comprise an electronic signal carried over a telecommunications carrier such as an RF carrier, optical carrier or other suitable carrier medium.

The method starts at step 220, at which the message blocks to be signed are received into the method. Process control then flows to step 222 where a bit or byte stream of the transaction reference block, organisation block, validation block and the current service block input at step 220 is formed.

At step 224, the bytestream is input to the hash digest algorithm to yield a hash digest value. Process control for the method then proceeds to step 226 at which step the hash digest is signed with the secret key of the organisation identified in block 206 to form a signature. At step 228, the signature is placed in a signature block 204 as a component thereof, together with the relevant digital certificate or digital certificate chain.

At step 230, it is decided whether or not there is another service block for signing. If the result at step 230 is “yes”, then process control flows back to step 220, whereas if the result is “no”, process control flows to step 232 where the method is halted.

FIG. 13 illustrates a flow diagram for a method for handling a service message 200 such as illustrated in FIG. 11 and formed by way of the method described with reference to FIG. 12. The method of the flow diagram of FIG. 13 may be implemented on a computer system in the manner described above with reference to FIG. 12.

At step 240, the message is received at the service requested in one of the service blocks 210 or 212. Typically, only data required by a legacy service is passed to the legacy service. The message is processed by the legacy service dependant on that legacy service before a response is sent back to the message manager. Before the service is actioned, the signature related to that service is verified.

At step 242, the service block corresponding to the service at which the message is received is identified, for example service block 210, and the relevant information in the signature block 204 is interrogated to identify which other message blocks are associated with that service block for forming the digital signature of that block. Additionally, signature block 204 is interrogated to determine which hash digest algorithm and encryption algorithms were used in creating the relevant signature. Process control for the method then flows to step 244 where a bytestream is formed of the relevant blocks identified in step 242, and in their designated order. At step 246, the bytestream is input to the hash digest algorithm identified in step 242, to provide a hash digest. Process control then flows to step 248 where the signature associated with the relevant service block is identified in signature block 204 and decrypted with the public key found in the digital certificate associated with that signature, to form a decrypted hash digest. Of course, step 248 could be done before steps 244 and 246 or they may be carried out simultaneously.

At step 250, the calculated hash digest is compared with the decrypted hash digest. If they are the same, then the process control flows to step 252 where the signatures are validated by calling the validation service requested in service block 214 of the transaction message. The validation or verification service is substantially as described above with reference to FIG. 2.

If the hash digests are not the same, then the service request verification method illustrated in FIG. 13 is ended and no service request is fulfilled. Typically, the relevant service will send a request fail message back to the originator of the transaction message to indicate that the service request has failed.

If the hash digests are the same then the request is actioned by the service, for example a call may be made to a legacy payment service to instruct payment, with appropriate data being passed to an interface or gateway to the legacy system.

Another embodiment in accordance with the present invention will now be described with reference to FIG. 14. FIG. 14 illustrates a computer network system comprising an originator 280, from which service messages are transmitted to a proxy server 282. The proxy server 282 is capable of communication with either one of, or both of, service 1-284 and 2-286.

Proxy server 282 operates as a gateway or portal to service 1 and service 2. Preferably, originator 280 is unaware that proxy server 282 serves two services 284,286, but merely sends suitable communications to the proxy server 282, which are then routed to service 1 or service 2 as necessary.

In accordance with an embodiment of the present invention, proxy server 282 receives a service message 200, such as illustrated in FIG. 11. For such a proxy server 282, service 1 may comprise an invoice discounting service, and service 2 may comprise an insurance service. Proxy server 282 may comprise a validation service or, optionally, a validation service may be provided as a further service, coupled to the proxy server. In an illustrative example of an application of this embodiment, originator 280 forms a service message 200 comprising a service block as illustrated in FIG. 11. The proxy server 282 receives the service message 200 and splits it up, such that the respective service blocks and the associated common blocks are transmitted to respective services 1 or 2. For example, proxy server 282 receives message 200 and translates it into two sub-messages. A first service message is formatted to be received by service 1 and comprises the transaction reference block 202, the organisation block 206, the validation service block 214 and the invoice discounting block 210. This new message is then transmitted to service 1 where it may be verified and validated. Providing the validation and verification are passed, then the invoice discounting service can be initiated. Additionally, proxy server 282 configures a second service message comprising transaction reference block 202, organisation block 206, validation service block 214 and insurance service block 212. This second message is transmitted to service 2 which performs the necessary verification and validation on the service, and providing this is passed, then invokes the insurance service.

Insofar as embodiments of the invention described above are implementable, at least in part, using a software-controlled programmable processing device such as a Digital Signal Processor, microprocessor, other processing devices, data processing apparatus or computer system, it will be appreciated that a computer program for configuring a programmable device, apparatus or system to implement the foregoing described methods is envisaged as an aspect of the present invention. The computer program may be embodied as source code and undergo compilation for implementation on a processing device, apparatus or system, or may be embodied as object code. The skilled person would readily understand that the term computer in its most general sense encompasses programmable devices such as referred to above, and apparatus and systems incorporating such programmable devices.

Suitably, the computer program is stored on a carrier medium in machine or device readable form, for example in solid-state memory or magnetic memory such as disc or tape and the processing device utilises the program or a part thereof to configure it for operation. The computer program may be supplied from a remote source embodied in a communications medium such as an electronic signal, including radio frequency carrier wave or optical carrier wave. Such carrier media are also envisaged as aspects of the present invention.

In view of the foregoing description it will be evident to a person skilled in the art that various modifications may be made within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A method for forming a service message for a multi-service environment, said method comprising:
digitally signing one or more message components for a first part of a service message;
digitally signing one or more message components for a second part of said service message; and
forming said service message from said first and second parts, and first and second digital signatures of said first and second parts.

2. A method according to claim 1, wherein at least one message component is common to both said first and second parts of said service message.

3. A method according to claim 1, further comprising associating one or more message components relating to a first service with each other to form said first part, and associating said one or more message components relating to a second service with each other to form said second part.

4. A method according to claim 1, wherein said service message includes one or more message blocks, each comprising one or more message components.

5. A method according to claim 4, wherein at least one message block is common to both said first and second parts of said service message.

6. A method according to claim 5, wherein two or more blocks comprising one of said first or second parts of said message are related to each other.

7. A method according to claim 1, further comprising forming said service message such that cryptographic data for said service message is disposed in a separate part of said message from said first and second parts.

8. A method for decoding a service message comprising first and second parts respectively associated with first and second services of a multi-service environment, said method comprising:
receiving said service message at a first service;
verifying only said first part of said message at said service;
receiving said service message at a second service; and
verifying only said second part of said service message at said second service.

9. A program element comprising program code for configuring a computer system to form a service message for a multi-service environment, the program code operable to:
digitally sign one or more message components for a first part of a service message;
digitally sign one or more message components for a second part of said service message; and
form said service message from said first and second parts, and first and second digital signatures of said first and second parts.

10. A program element comprising program code translatable to configure a computer system to form a service message for a multi-service environment, the program code operable to:
receive said service message at a first service;
verify only said first part of said message at said service;
receive said service message at a second service; and
verify only said second part of said service message at said second service.

11. A program element comprising program code for configuring a computer system to decode a service message comprising first and second parts respectively associated with first and second services of a multi-service environment, the program code operable to:
verify only said first part of said message for said first service; and
verify only said second part of said message for said second service.

12. A program element comprising program code translatable to configure a computer system to decode a service message comprising first and second parts respectively associated with first and second services of a multi-service environment, the program code operable to:
verify only said first part of said message for said first service; and
verify only said second part of said message for said second service.

13. A computer-readable medium encoded with computer-readable program code for configuring a computer system to form a service message for a multi-service environment, the program code operable to:
digitally sign one or more message components for a first part of a service message;
digitally sign one or more message components for a second part of said service message; and
form said service message from said first and second parts, and first and second digital signatures of said first and second parts.

14. A computer-readable medium encoded with computer-readable program code translatable for configuring a computer system to form a service message for a multi-service environment, the program code operable to:
digitally sign one or more message components for a first part of a service message;
digitally sign one or more message components for a second part of said service message; and
form said service message from said first and second parts, and first and second digital signatures of said first and second parts.

15. A computer-readable medium encoded with computer-readable program code for configuring a computer system to decode a service message comprising first and second parts respectively associated with first and second services of a multi-service environment, the program code operable to:
verify only said first part of said message for said first service; and
verify only said second part of said message for said second service.

16. A computer-readable medium encoded with computer-readable program code translatable for configuring a computer system to decode a service message comprising first and second parts respectively associated with first and second services of a multi-service environment, the program code operable to:
verify only said first part of said message for said first service; and
verify only said second part of said message for said second service.

17. An electronic signal encoding a service message for a multi-service environment, wherein first and second parts of said message are each separately digitally signed.

18. An electronic signal according to claim 17, wherein cryptographic data for said message is a third, separate part of said message.

19. An electronic signal according to claim 17, wherein said first part of said message is associated with a first service, and said second part of said message is associated with a second service.

20. An electronic signal according to claim 17, comprising a plurality of message components forming said message, said first and second parts each comprising one or more of said components.

21. An electronic signal according to claim 17, wherein at least one message component is common to both first and second parts of said service message.

22. An electronic signal according to claim 20, comprising a plurality of message blocks each including one or more of said message components, said first and second parts each comprising one or more of said message blocks.

23. An electronic signal according to claim 22, wherein two or more blocks comprising said first or second parts of said message are related to each other.

24. A computer system for a multi-service environment, the computer system configured to:
receive two or more message components for a service message;
digitally sign one or more of said message components for a first part of said service message;
digitally sign one or more of said message for a second part of said service message; and
form said service message from said first and second parts, and first and second digital signatures of said first and second parts.

25. A computer system according to claim 24, wherein at least one message component is common to both said first and second parts of said service message.

26. A computer system according to claim 24, further configured to associate one or more message components relating to a first service with each other to form said first part, and associating said one or more message components relating to a second service with each other to form said second part.

27. A computer system according to claim 24, wherein said first part of said message is associated with a first service, and said second part of said message is associated with a second service.

28. A computer system according to claim 27, wherein at least one message block is common to both said first and second parts of said service message.

29. A computer system according to claim 27, wherein two or more blocks comprising one of said first or second parts of said message are related to each other.

30. A computer system according to claim 24, further configured to form said service message such that cryptographic data for said service message is disposed in a separate part of said message from said first and second parts.

31. Apparatus for forming a service message for a multi-service environment, comprising:
means for receiving one or more components for a service message;
means for digitally signing one or more of said components for a first part of said service message;
means for digitally signing one or more of said components for a second part of said service message; and
means for creating said service message from said first and second parts, and first and second digital signatures of said first and second parts.

32. A computer system for a multi-service environment, the computer system configured to:
receive a service message comprising first and second parts respectively associated with first and second services of said multi-service environment;
verify only said first part of said service message for said first service; and
verify only said second part of said service message for said second service.

33. Apparatus for decoding a service message comprising first and second parts respectively associated with first and second services of a multi-service environment, said apparatus comprising:
means for receiving said service message;
means for verifying only said first part of said service message for said first service; and
means for verifying only said second part of said service message for said second service.

34. A computer network comprising at least one computer system connectable to at least one further computer system via a network, the at least one computer system configured to:
receive two or more message components for a service message;
digitally sign one or more of said message components for a first part of said service message;
digitally sign one or more of said message for a second part of said service message; and
form said service message from said first and second parts, and first and second digital signatures of said first and second parts.

35. A computer network comprising at least one computer system connectable to at least one further computer system via a network, the at least one computer system configured to:
receive a service message comprising first and second parts respectively associated with first and second service of said multi-service environment;
verify only said first part of said service message for said first service; and
verify only said second part of said service message for said second service.
